(19) United States
(12) Patent Application Publication
(10) Pub. No.: US 2013/0118397 A1
(43) Pub. Date: May 16, 2013

(54) BIRD CONTROL DEVICE

(71) Applicants: CHAO SHUI LIN, CHANG HUA HSIEN (TW); FENG CHIA CHUANG, CHANG HUA HSIEN (TW); YUAN WU CHING, CHANG HUA HSIEN (TW); TZU WEI CHUANG, CHANG HUA HSIEN (TW); TZU HAN CHUANG, CHANG HUA HSIEN (TW)

(72) Inventors: CHAO SHUI LIN, CHANG HUA HSIEN (TW); FENG CHIA CHUANG, CHANG HUA HSIEN (TW); YUAN WU CHING, CHANG HUA HSIEN (TW); TZU WEI CHUANG, CHANG HUA HSIEN (TW); TZU HAN CHUANG, CHANG HUA HSIEN (TW)

(73) Assignee: TAIWAN MIRROR GLASS ENTERPRISE CO., LTD., CHANG HUA HSIEN (TW)

(21) Appl. No.: 13/296,338

(22) Filed: Nov. 15, 2011

(51) Int. Cl. A01M 29/10; A01M 29/16

(52) U.S. Cl. 116/22 A

(57) ABSTRACT

A bird control device includes a base with a control unit, a power supply unit, a sound generating device, an emitting unit, and a flashing light unit and Light Emitting Diodes connected thereto. The control unit controls the operation of the sound generating device, the emitting unit, and the flashing light unit and Light Emitting Diodes the base. The power supply unit supplies electric power to the bird control device. The sound generating device generates different types of sounds and the flashing light unit and Light Emitting Diodes control unit generates flashing light to keep birds away from the sites where the bird control device is located.

### FIELD OF THE INVENTION

The present invention relates to a bird control device, and more particularly, to a bird control device which generates different types of sounds and flashing lights to expel the birds away.

### BACKGROUND OF THE INVENTION

There are many different types of bird control devices for keeping the birds away from the sites so as to prevent the birds from eating the crops or to prevent bird strikes to the air planes. For the prevention of the birds from the farm sites, farmers build reflection strips, nets, flashing lights or crackers in the farm sites to keep the birds away from the crops.

Taiwan Utility Models 91220184 discloses a bird control device which includes an emitting gun, a power supply for providing electric power to the device and a control box with control circuits received therein so as to activate or stop a laser generating device to generate laser beams. The laser generating device is controlled by the control box. A regulating device which regulates the laser beams to build a laser beams net and controls the frequency of the flashing of the laser beams.

Taiwan Utility Models 92221801 discloses a bird control device which includes a control platform to control the whole bird control device, a back-up unit which can also control the whole bird control device and is controlled by programs to be a back-up for the control platform, a microwave transmitting system for communication between the control platform and the back-up unit, one or more emitting units arranged at pre-set positions and each have a client end which receives the commands to adjust the angles thereof and to shoot, one or more cameras which are located to record each of the emitting units and send feedbacks to the control platform and the back-up unit stores a back-up file in the back-up unit.

However, the devices mentioned above using sounds and flashing lights are located at fixed positions and the mold or patterns for generating the sounds and the flashing lights are fixed, so that the birds gradually learn the patterns of operation and will came again. Furthermore, these conventional devices are bulky and inconvenient for moving.

The present invention intends to provide a bird control device which is compact in size and can generate different types of sounds and lights to keep the birds from sites.

### SUMMARY OF THE INVENTION

The present invention relates to a bird control device and comprises a base and a control unit connected to the base. A power supply unit is connected to the control unit and provides electric power to the bird control device. A sound generating device is electrically connected to the control unit and receives commands from the control unit so as to activate or stop the sound generating device. An emitting unit is electrically connected to the control unit and receives commands from the control unit so as to activate or stop the emitting unit. A flashing light unit and Light Emitting Diodes is electrically connected to the control unit and receives commands from the control unit to be activated or stopped. The sound generating device generates different types of sounds and the flashing light unit and Light Emitting Diodes generates flashing light to keep birds away from the sites where the bird control device is located.

The primary object of the present invention is to provide a bird control device which has a control unit to control the operation of the sound generating device, the emitting unit and the flashing light unit and Light Emitting Diodes so as to keep birds away from the bird control device.

Another object of the present invention is to provide a compact bird control device which is small and easily carried.

Yet object of the present invention is to provide a bird control device wherein the emitting unit can be activated by different time settings so as to obtain flexible activation patterns.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bird control device of the present invention;

FIG. 2 is another perspective view to show the bird control device of the present invention;

FIG. 3 shows the arrangement of the parts of the bird control device of the present invention;

FIG. 4 is a perspective view to show the bird control device of the present invention wherein the case is closed;

FIG. 5 shows the diagram of the main parts of the bird control device of the present invention;

FIG. 6 shows the rotation of the sound generating device of the bird control device of the present invention, and

FIG. 7 shows the different positions of the emitting device of the bird control device of the present invention.

### DETAILED DESCRIPTION OF THE PREFERRED EMBODIMENT

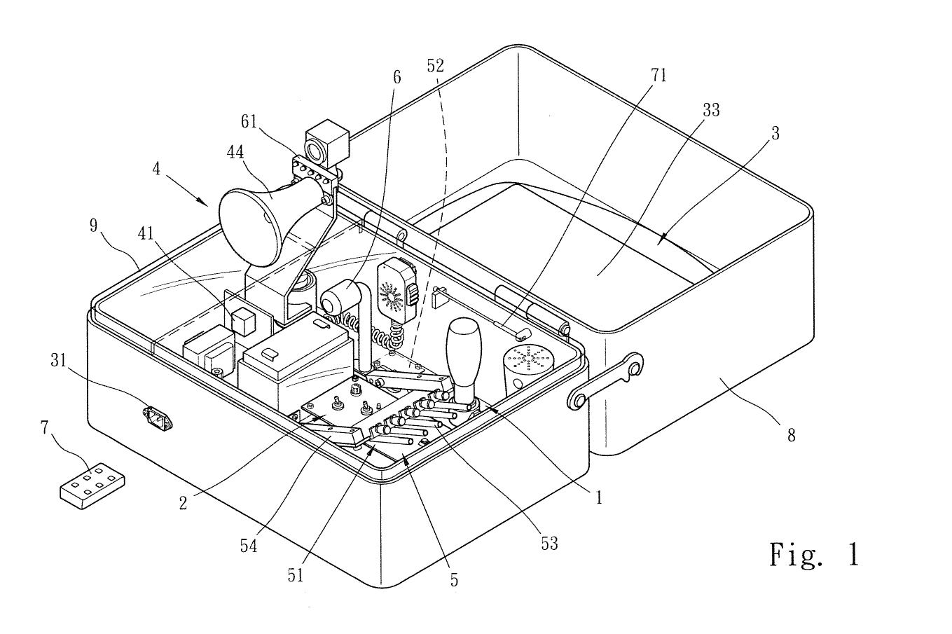

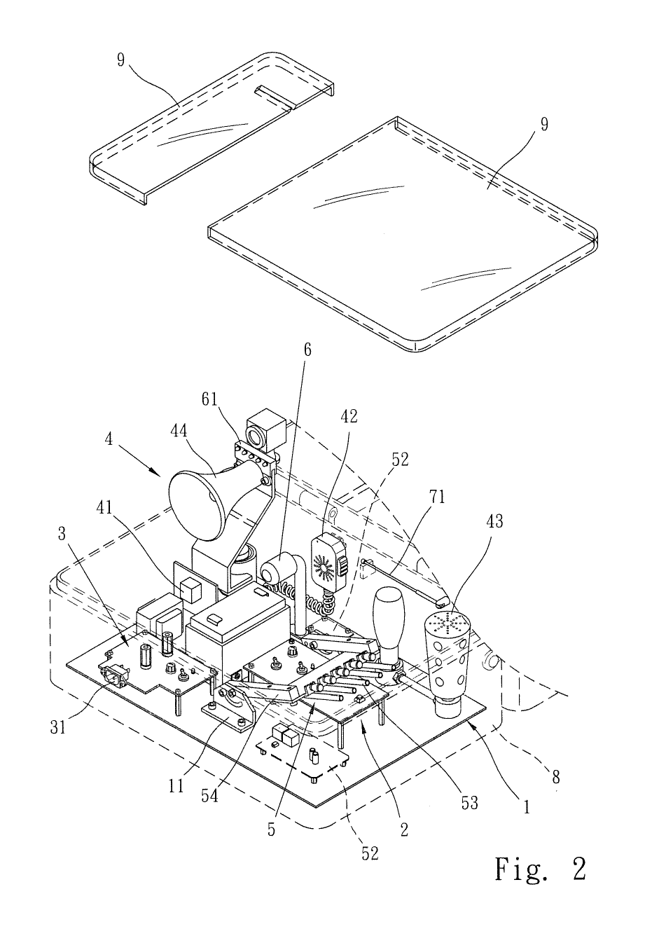

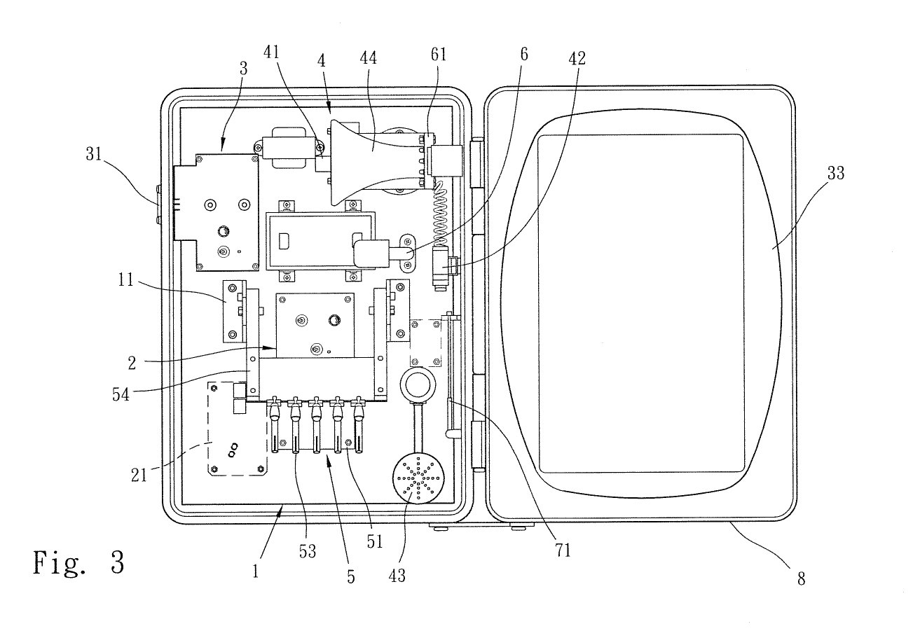

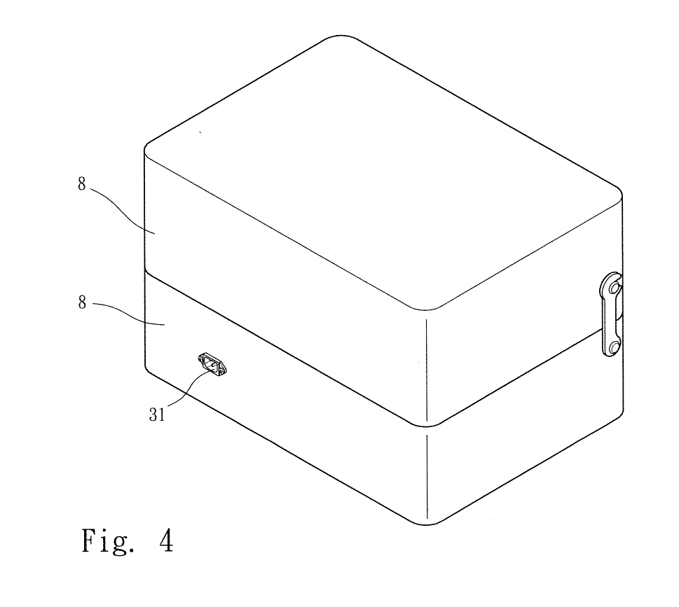

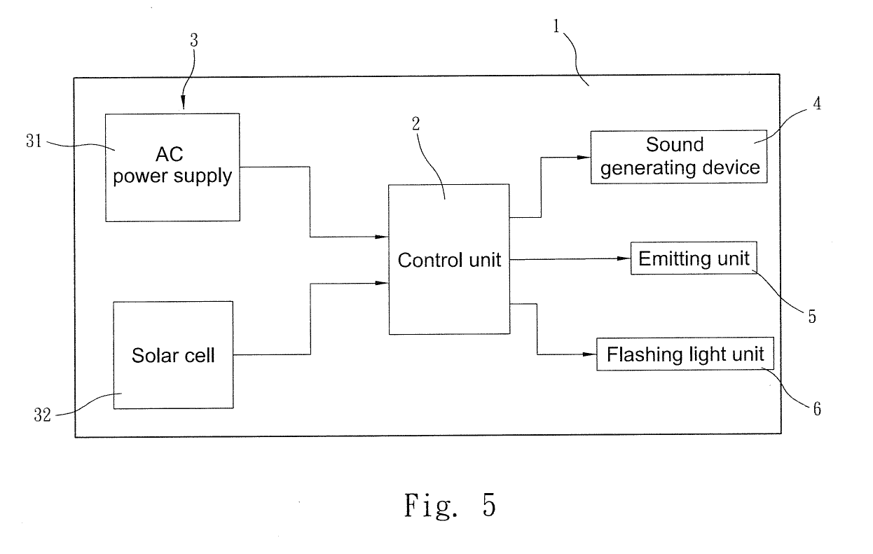

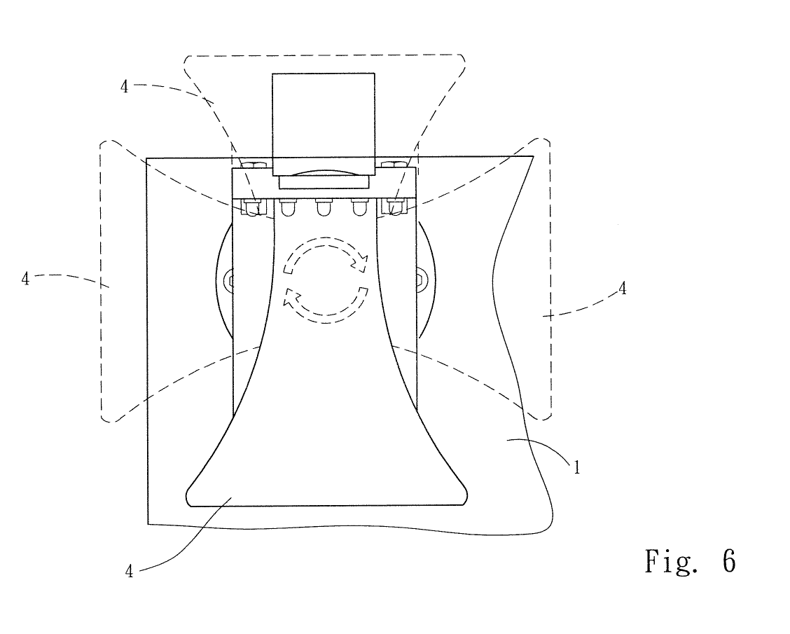

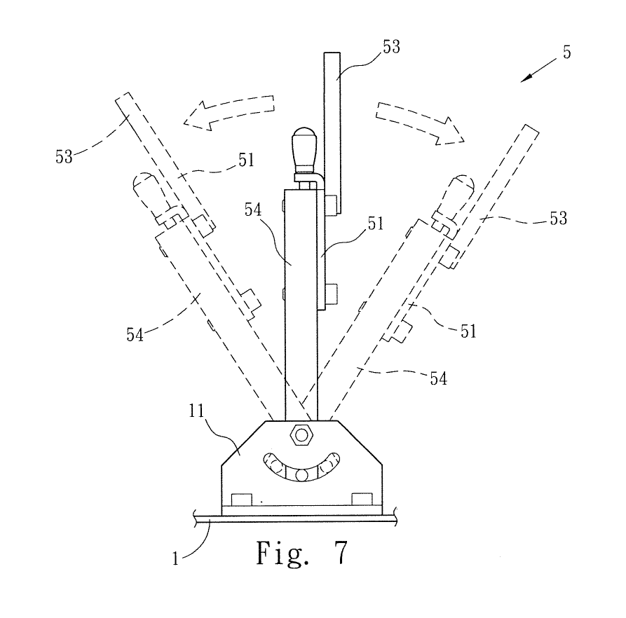

Referring to FIGS. 1 to 7, the bird control device of the present invention comprises a base 1, a control unit 2, a power supply unit 3, a sound generating device 4, an emitting unit 5, a flashing light unit 6 and Light Emitting Diodes 61 and a remote controller 7.

The control unit 2 is connected to the base 1 and has a circuit board 21 to control the whole bird control device.

The power supply unit 3 is connected to the base 1 and electrically connected to the control unit 2 so as to provide electric power to the bird control device. The power supply unit 3 can be an AC power supply or a solar cell 32 which has a solar panel 33 to transfer the light into electric power and stored in the solar cell 32.

The sound generating device 4 is connected to the base 1 and electrically connected to the control unit 2. The sound generating device 4 receives commands from the control unit 2 so as to be activated or stopped by the commands. The commands also control the pivotal angles of the speaker 44. The speaker 44 is pivotably connected to the base 1 and pivotable 360 degrees relative to the base 1. The sound generating device 4 has a digital audio storage unit 41 which stores sounds of predators, cars, human and the like so that the sound generating device 4 can deliver pre-set or desired sounds. The users can use portable speakers 42 to generate sounds or use air speaker 43 which generates significant sound by pressurized air. The air speaker 43 can be controlled by the control unit 2.

The emitting unit 5 is electrically connected to the control unit 2 and receives commands from the control unit 2 so as to be activated or stopped. The emitting unit 5 includes an emitting board 51 and a circuit board 52 on the base 1. The emitting board 51 has multiple tubes 53 in which crackers are received, or a gunpowder ignition device is connected to the emitting board 51 and is controlled and activated by the control circuit 52 so as to generate noise. The emitting board 51 has two supports 54 connected to two sides of the underside thereof and the supports 54 are pivotably connected to two connection members 11 on the base 1. Each connection member 11 has a curved slot 12 with which the support 54 is connected so that the emitting board 51 is adjustably inclined relative to the base 1 by the at least one support 54. The circuit board 52 receives the commands from the control unit 2 and controls inclination of the emitting board 51 and activates the emitting unit 5. The circuit board 52 controls the timing of the activation of the crackers and the gunpowder ignition device.

The flashing light unit 6 and Light Emitting Diodes 61 is located on the base 1 and respectively electrically connected to the control unit 2 and receive commands from the control unit 2 so as to be activated or stopped. The flashing light unit 6 and Light Emitting Diodes 61 is a light flashing device so as to generate flashing light. The remote controller 7 is electronically communicates with the control unit 2 by wireless signals to as to control the control unit 2. When the receiving of the signals is poor, the antenna 71 can be pulled out form the case 8 to have better receiving feature.

The sound generating device 4, the emitting unit 5, the flashing light unit 6, and the Light Emitting Diodes 61 generate sounds, flashing lights to keep the birds away from the site where the bird control device is located. The bird control device of the present invention is compact and is easily received in the case 8 for convenience of carry. When the emitting unit is not in use, a cover board 9 is used to cover the most of the parts so as prevent from being contaminated by dust and rain.

When assembling, the control unit 2, the power supply unit 3, the sound generating device 4, the emitting unit 5, and the flashing light unit 6 and the Light Emitting Diodes 61 are connected to the base 1, and the power supply unit 3 is connected to the control unit 2 and provides electric power to the bird control device. The control unit 2, the sound generating device 4, the emitting unit 5 and the flashing light unit 6 and the Light Emitting Diodes 61 are respectively connected to the control unit 2.

The control unit 2 activates the sound generating device 4 to generate sounds by using the speaker 44, the portable speakers 42 and the air speaker 43. The emitting unit 5 can be adjusted its inclination to activate the crackers and the gunpowder ignition device to generate noise. The flashing light unit 6 and Light Emitting Diodes 61 generates flashing lights to expel the birds.

The bird control device of the present invention is compact and is easily carried to different sites so that birds are not likely notice the existence of the bird control device. Therefore, the result for keeping birds out from the sides is better than the conventional bird control devices.

The emitting unit 5 can be set to be activated by different time settings so that birds are difficult to learn the mold of the operation of the emitting unit 5. The remote controllers can control the bird control device at distance and this is convenient for the users to use the bird control device.

While we have shown and described the embodiment in accordance with the present invention, it should be clear to those skilled in the art that further embodiments may be made without departing from the scope of the present invention.

What is claimed is:

1. A bird control device comprising:
a base and a control unit connected to the base;
a power supply unit connected to the control unit;
a sound generating device electrically connected to the control unit and receiving commands from the control unit so as to be activated or stopped;
an emitting unit electrically connected to the control unit and receiving commands from the control unit so as to be activated or stopped, and
a flashing light unit and Light Emitting Diodes electrically connected to the control unit and receiving commands from the control unit so as to be activated or stopped.

2. The device as claimed in claim 1, wherein the power supply unit is an AC power supply.

3. The device as claimed in claim 1, wherein the power supply unit is a solar cell.

4. The device as claimed in claim 1, wherein the sound generating device is pivotable relative to the base by the commands from the control unit.

5. The device as claimed in claim 1, wherein the sound generating device has a digital audio storage unit to provide multiple types of sounds.

6. The device as claimed in claim 1, wherein the emitting unit includes an emitting board and a circuit board on the base, the emitting board has at least one support connected to an underside thereof and the at least one support is pivotably connected to a connection member on the base so that the emitting board is inclined relative to the base by the at least one support, the circuit board controls inclination of the emitting board and activates the emitting unit.

7. The device as claimed in claim 6, wherein the emitting board has multiple crackers which are controlled and activated by the control circuit.

8. The device as claimed in claim 6, wherein the emitting board has a gunpowder ignition device which is controlled and activated by the control circuit so as to generate noise.

9. The device as claimed in claim 1, wherein the flashing light unit and Light Emitting Diodes is a light flashing device so as to generate flashing light.

10. The device as claimed in claim 1 further comprising a remote controller which electronically communicates with the control unit by wireless signals to as to control the control unit.
